(19) United States
(12) Patent Application Publication
(10) Pub. No.: US 2019/0148095 A1
(43) Pub. Date: May 16, 2019

(54) CONTACT SWITCHING DEVICE AND ELECTROMAGNETIC RELAY USING SAME

(71) Applicant: OMRON Corporation, Kyoto (JP)

(72) Inventors: Ryota Minowa, Kumamoto (JP); Shingo Mori, Kumamoto (JP)

(73) Assignee: OMRON Corporation, Kyoto (JP)

(21) Appl. No.: 16/093,458

(22) PCT Filed: Feb. 27, 2017
(86) PCT No.: PCT/JP2017/007517

§ 371 Date: Oct. 12, 2018

(30) Foreign Application Priority Data
Apr. 22, 2016 (JP) 2016-086448

(51) Int. Cl. H01H 50/42; H01H 50/18; H01H 50/14

(52) U.S. Cl. CPC H01H 50/42; H01H 50/546; H01H 50/14; H01H 50/18

(57) ABSTRACT

A contact switching device includes a pair of fixed contact terminals that include fixed contacts at one-side ends and are arranged side by side, a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts, and a pair of leading terminals configured to respectively fix fixed portions, provided at one-side ends, to other-side ends of the fixed contact terminals. An extension portion continuing to each of the fixed portions or at least one of the leading terminals is disposed so as to follow the movable contactor.

### TECHNICAL FIELD

The present invention relates to a contact switching device and particularly relates to a contact switching device, capable of reducing an electromagnetic repulsive force that is generated when a large current is applied, such as an electromagnetic relay.

### BACKGROUND ART

Conventionally, when a large current is applied to an electromagnetic relay as shown in Patent Document 1, an electromagnetic repulsive force is generated at the time of contact between a fixed contact and a movable contact. For this reason, the contact pressure between the fixed contact and the movable contact decreases, and the fixed contact and the movable contact might be separated from each other. This results in not only a defect of low contact reliability, but also a defect of contact welding tending to occur due to occurrence of arc. It is thus conceivable, for example, to increase the number of turns of a coil in an electromagnet unit so as to increase a mutual attractive force between the fixed contact and the movable contact and reduce the electromagnetic repulsive force described above.

### PRIOR ART DOCUMENT

### Patent Document

Patent Document 1: Japanese Unexamined Patent Publication No. 2013-187134

### SUMMARY OF THE INVENTION

### Problems to be Solved by the Invention

However, increasing the number of turns of the coil increases the size of the electromagnet unit and the size of the electromagnetic relay. Moreover, when a leading terminal is connected to a contact terminal including the fixed contact, the size of the electromagnetic relay further increases, which is problematic.

In view of the above problem, it is an object of the present invention to provide a contact switching device of a small size with high contact reliability, and provide an electromagnetic relay using this contact switching device.

### Means for Solving the Problem

For solving the above problem, an electromagnetic relay according to an aspect of the present invention is configured as follows. A contact switching device includes: a pair of fixed contact terminals that include fixed contacts at one-side ends and are arranged side by side; a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts; and a pair of leading terminals configured to respectively fix fixed portions, provided at one-side ends, to other-side ends of the fixed contact terminals. An extension portion continuing to each of the fixed portions of at least one of the leading terminals is disposed so as to follow the movable contactor, and a current is applied to each of the fixed contact terminals and the movable contactor via the pair of leading terminals.

### Effect of the Invention

According to the aspect of the present invention, when a large current flows between the fixed contact and the movable contact, the large current flowing through the extension portion generates a magnetic field, and the magnetic force of the magnetic field can reduce an electromagnetic repulsive force generated between the fixed contact and the movable contact. In particular, it is not necessary to increase the number of turns of a coil in an electromagnet unit in order to increase an attractive force between the contacts. It is thus possible to improve the contact reliability while avoiding an increase in size of the device.

### BRIEF DESCRIPTION OF THE DRAWINGS

FIG. 1 is a perspective view illustrating an electromagnetic relay of a first embodiment according to the present invention.

FIG. 2 is a perspective view of the electromagnetic relay illustrated in FIG. 1, seen from a different angle.

FIG. 3 is an exploded perspective view of the electromagnetic relay illustrated in FIG. 1.

FIG. 4 is a perspective view illustrating a state in which an outer cover has been removed from FIG. 1.

FIG. 5 is a perspective view illustrating a state where a case has been removed from FIG. 4.

FIG. 6 is a perspective view illustrating a state in which a part of constituent parts has further been removed from FIG. 5.

FIG. 7 is a perspective view illustrating a state in which a part of constituent parts has further been removed from FIG. 6.

FIG. 8 is a perspective view illustrating a state in which a part of constituent parts has further been removed from FIG. 7.

FIG. 9 is a perspective view illustrating a state in which a part of constituent parts has further been removed from FIG. 8.

FIG. 10 is a front sectional perspective view of FIG. 5.

FIG. 11 is a right-side sectional perspective view of FIG. 5.

FIG. 12 is a schematic plan view illustrating a current path.

FIG. 13 is a schematic front view illustrating the current path.

FIG. 14 is a sectional view taken along line I-I of FIG. 13.

FIG. 15 is an exploded perspective view illustrating an electromagnetic relay according to a second embodiment of the present invention.

FIG. 16 is a front sectional perspective view of the electromagnetic relay illustrated in FIG. 15.

FIG. 17 is a right-side sectional perspective view of the electromagnetic relay illustrated in FIG. 15.

FIG. 18 is a schematic plan view illustrating a current path.

FIG. 19 is a schematic front view illustrating the current path.

FIG. 20 is a sectional view taken along line II-II of FIG. 19.

FIG. 21 is a schematic perspective view illustrating a current path of an electromagnetic relay according to a third embodiment of the present invention.

FIG. 22 is a schematic plan view illustrating the current path.

FIG. 23 is a schematic front view illustrating the current path.

FIG. 24 is a sectional view taken along line III-Ill of FIG. 23.

FIG. 25 is a schematic perspective view illustrating a current path of an electromagnetic relay according to a fourth embodiment of the present invention.

FIG. 26 is a schematic plan view illustrating the current path.

FIG. 27 is a schematic front view illustrating the current path.

FIG. 28 is a sectional view taken along line IV-IV of FIG. 27.

FIG. 29 is a schematic perspective view illustrating a current path of an electromagnetic relay according to a fifth embodiment of the present invention.

FIG. 30 is a schematic plan view illustrating the current path.

FIG. 31 is a schematic front view illustrating the current path.

FIG. 32 is a sectional view taken along line V-V of FIG. 31.

FIG. 33 is a schematic perspective view illustrating a current path of an electromagnetic relay according to a sixth embodiment of the present invention.

FIG. 34 is a schematic plan view illustrating the current path.

FIG. 35 is a schematic front view illustrating the current path.

FIG. 36 is a sectional view taken along line VI-VI of FIG. 35.

FIG. 37 is a schematic perspective view illustrating a current path of an electromagnetic relay according to a seventh embodiment of the present invention.

FIG. 38 is a schematic plan view illustrating the current path.

FIG. 39 is a schematic front view illustrating the current path.

FIG. 40 is a sectional view taken along line VII-VII of FIG. 39.

FIG. 41 is a schematic perspective view illustrating a current path of an electromagnetic relay according to an eighth embodiment of the present invention.

FIG. 42 is a schematic plan view illustrating the current path.

FIG. 43 is a schematic front view illustrating the current path.

FIG. 44 is a sectional view taken along line VIII-VIII of FIG. 43.

### MODES FOR CARRYING OUT THE INVENTION

Before continuing with the description of the present invention, the same reference numerals are provided to the same parts in the accompanying drawings.

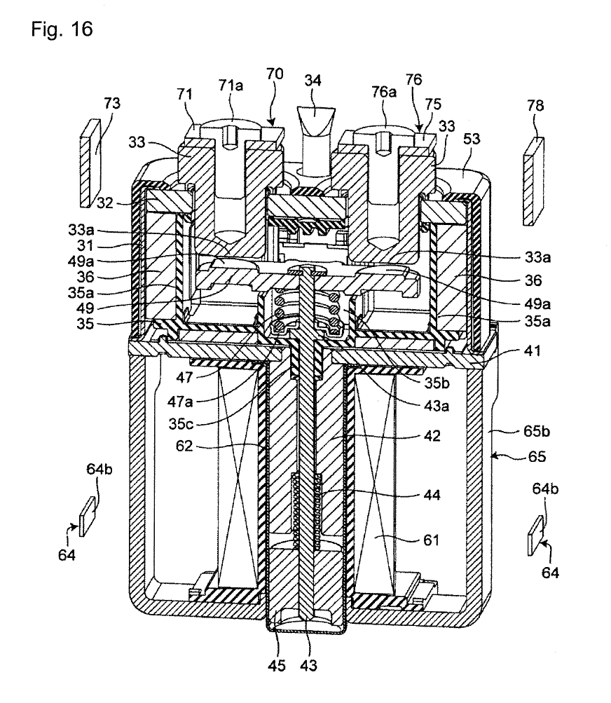

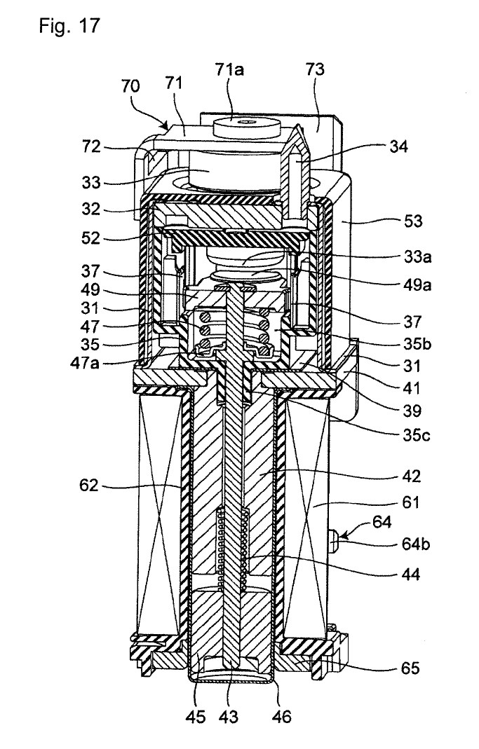

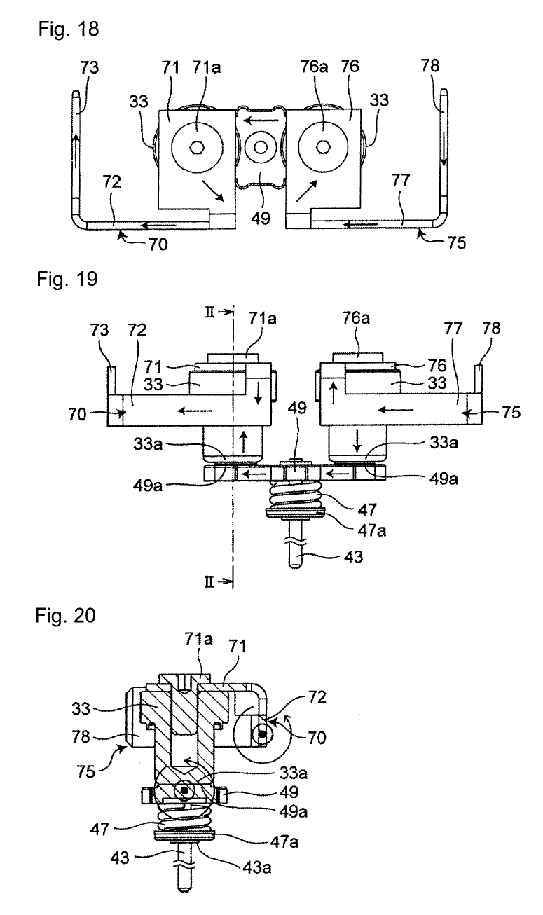

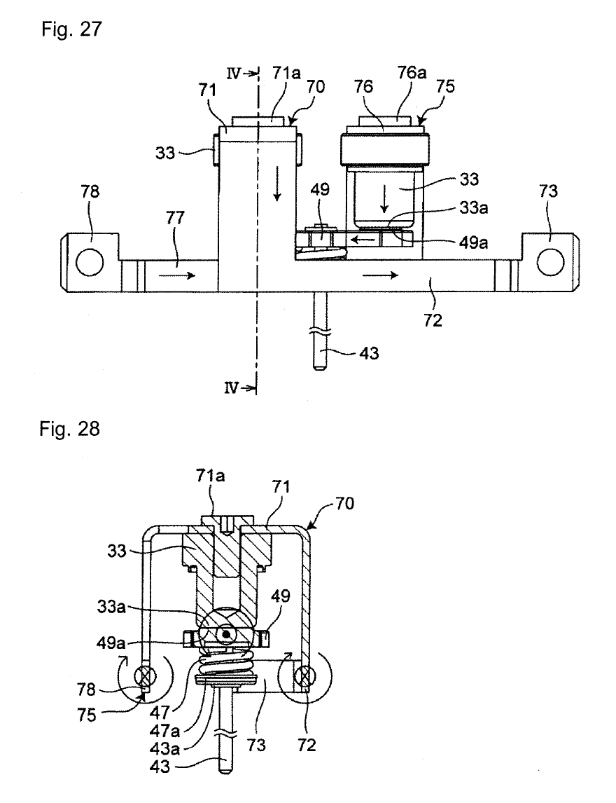

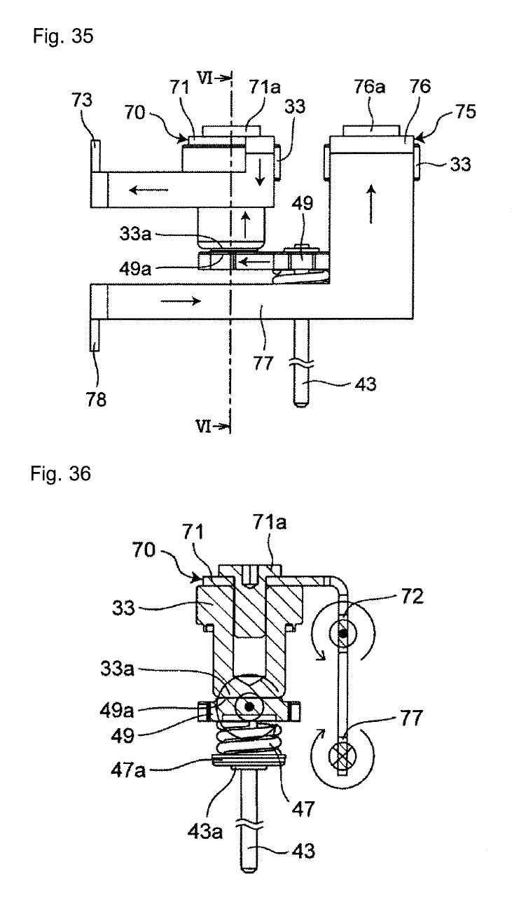

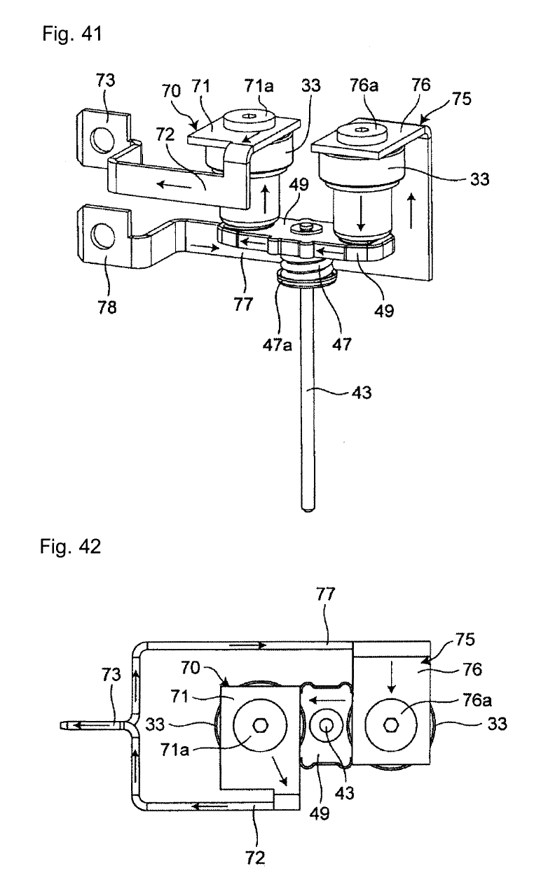

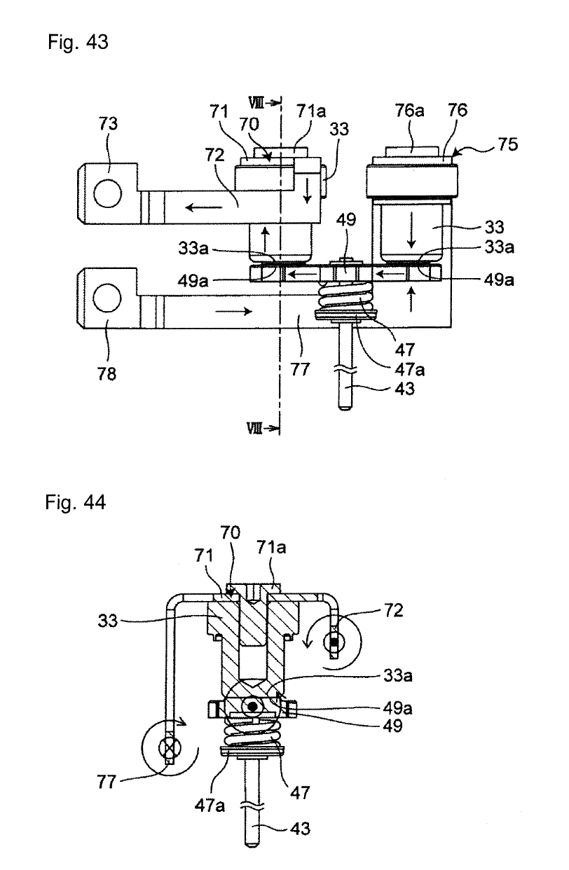

A case where a contact switching device according to an embodiment of the present invention is applied to an electromagnetic relay will be described with reference to the attached drawings of FIGS. 1 to 44.

In the electromagnetic relay according to a first embodiment, as illustrated in FIGS. 1 to 14, a contact mechanism unit 30 and an electromagnet unit 60 are incorporated in a housing formed by assembling an outer cover 20 to a case 10. A pair of coil terminals 64, 64 and a pair of leading terminals 70, 75 protrude from the housing. The contact mechanism unit 30 is made up of a contact switching device at least including: a pair of fixed contact terminals 33,33 that each include a fixed contact 33a at one-side end and are arranged side by side; a movable contactor 49 that includes a pair of movable contacts 49a, 49a at both ends, and are disposed so as to bridge between the pair of fixed contact terminals 33,33, and supported so as to be able to reciprocate towards the fixed contact terminals 33,33, each of the movable contacts 49a facing each of the fixed contacts 33a so as to be able to come into contact with and separate from each of the fixed contacts 33a; and a pair of leading terminals 70, 75 configured to respectively fix fixed portions 71, 76, provided at one-side ends, to other-side ends of the fixed contact terminals 33.

Specifically, the contact mechanism unit 30 is incorporated in a sealed space made up of a metal tubular flange 31, a ceramic plate 32, a platy first yoke 41, and a bottomed cylindrical body 46. The electromagnet unit 60 drives the contact mechanism unit 30 externally from the sealed space. Therefore, as described later, the movable contactor 49 is supported so as to reciprocate toward the fixed contact terminal 33 based on the excitation and demagnetization of the electromagnet unit 60.

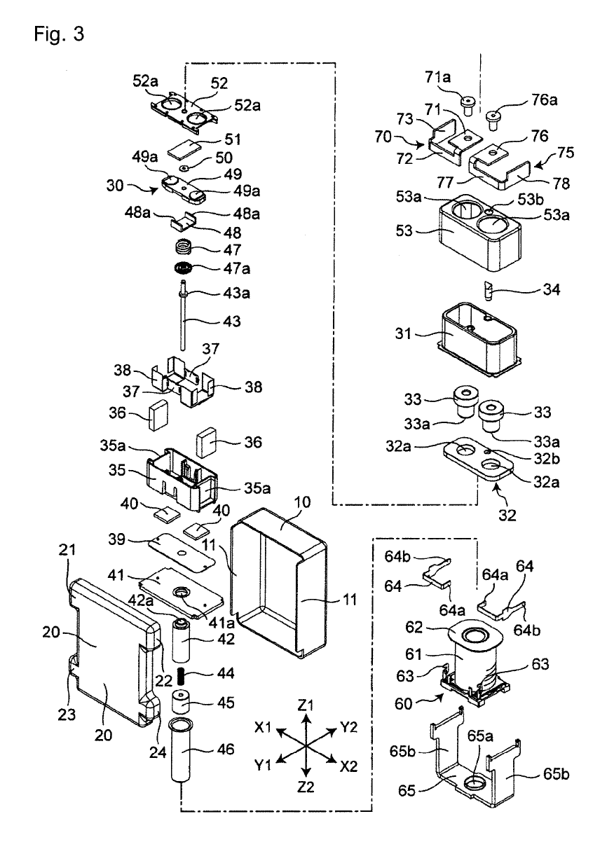

As illustrated in FIG. 3, the case 10 is a substantially box-shaped resin molded article. In the case 10, a pair of fitting ribs 11, 11 are projected in a Y1 direction at the opening edges of the side faces facing each other.

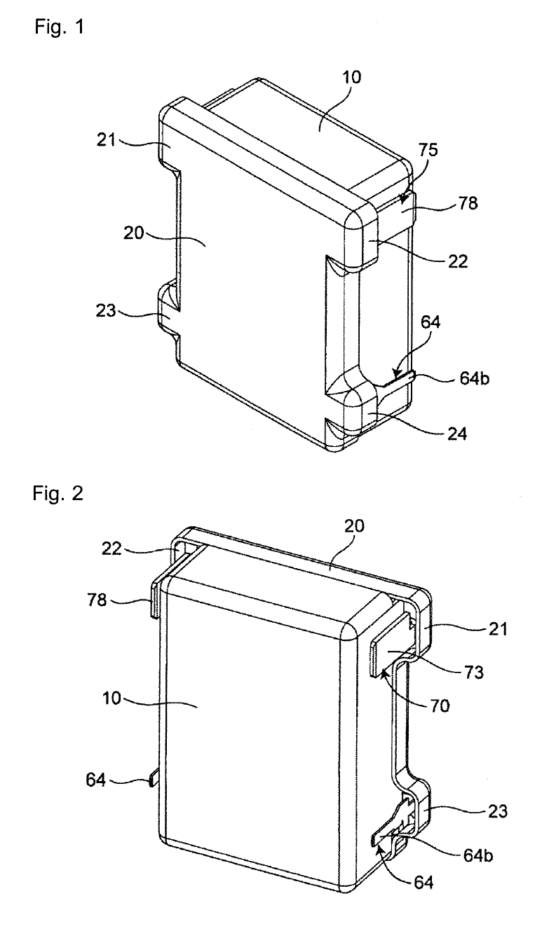

As illustrated in FIGS. 1 and 2, the outer cover 20 has a planar shape capable of covering an opening of the case 10 and has a shallow-bottomed box shape. In the outer cover 20, bulging portions 21, 22 are provided on the upper side of both side edges of the facing surfaces, and bulging portions 23, 24 are provided on the lower side thereof.

As described above, the contact mechanism unit 30 is incorporated in the sealed space formed of the metal tubular flange 31, the ceramic plate 32, the platy first yoke 41, and the bottomed cylindrical body 46. The contact mechanism unit 30 includes a holder 35, a cylindrical fixed iron core 42, a movable shaft 43, a movable iron core 45, and the movable contactor 49.

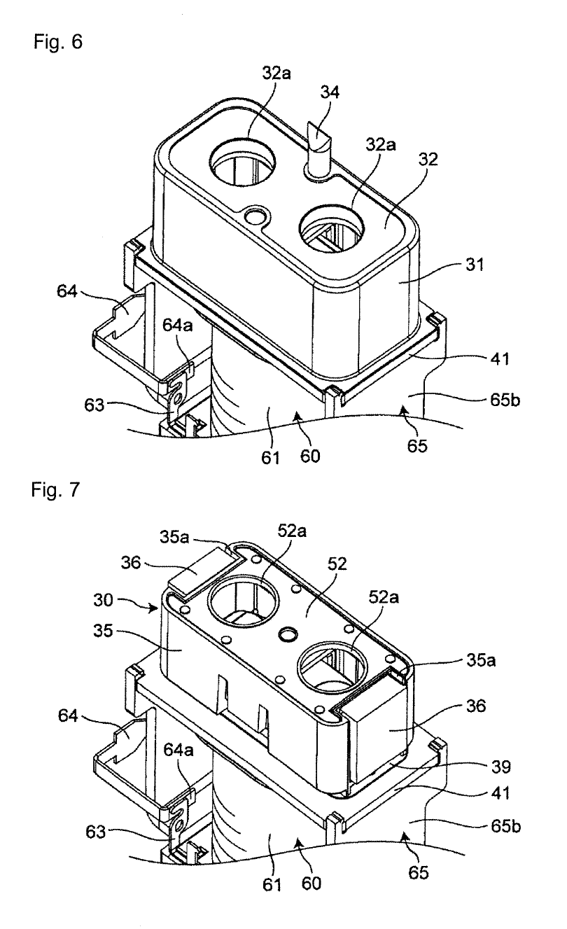

As illustrated in FIG. 3, the metal tubular flange 31 has a substantially tubular shape formed by pressing a metal plate. The ceramic plate 32 is brazed to the upper-side outer peripheral edge of the metal tubular flange 31. The platy first yoke 41, described later, is welded integrally with the lower-side outer peripheral edge of the metal tubular flange 31 (cf. FIG. 6).

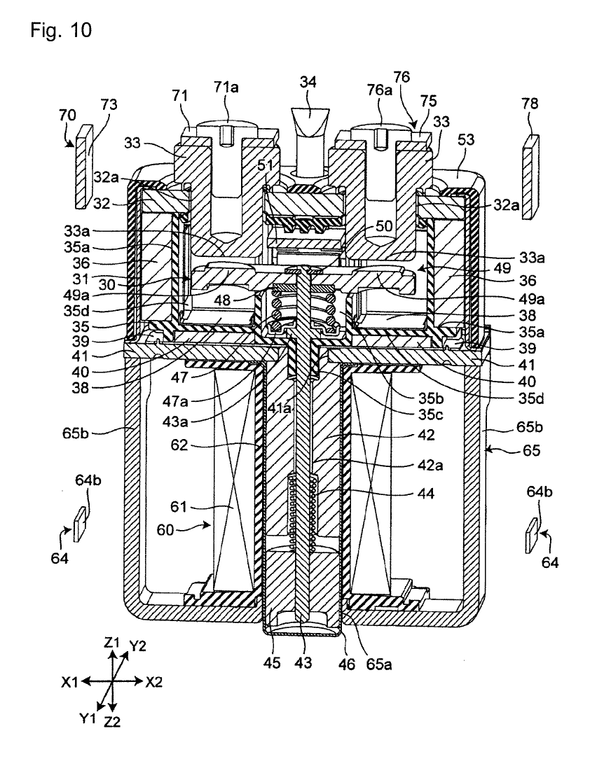

The ceramic plate 32 has a planar shape that can be brazed to the upper opening edge of the metal tubular flange 31. The ceramic plate 32 is provided with terminal holes 32a, 32a and a gas venting hole 32b. In the ceramic plate 32, a metal layer (not shown) is formed at the opening edge of the terminal hole 32a and the opening edge of the gas venting hole 32b. As illustrated in FIG. 10, the fixed contact terminal 33 is brazed to the terminal hole 32a in the ceramic plate 32. The fixed contact 33a is provided at the lower end of the fixed contact terminal 33. As illustrated in FIG. 11, a gas venting pipe 34 is brazed to the gas venting hole 32b in the ceramic plate 32.

The holder 35 is formed of a heat-resistant insulating material having a box shape and is accommodated in the metal tubular flange 31 (FIG. 10). Pocket portions 35a capable of holding permanent magnets 36 are formed on both outer side surfaces, facing each other, of the holder 35. Further, a central recess 35b (FIG. 10) having a planar square shape is formed lower by one level at the bottom center of the holder 35. A cylindrical insulating portion 35c (FIG. 10) is projected downward from the center of the central recess 35b. Even when a voltage becomes high through the path of the metal tubular flange 31, the platy first yoke 41 and the cylindrical fixed iron core 42 in the case of generation of arc, the cylindrical insulating portion 35c insulates the cylindrical fixed iron core 42 and the movable shaft 43 from each other, thereby preventing welding thereof. Further, the holder 35 is provided with a recess 35d (FIG. 10), in which an arc elimination piece 38 described later can be disposed, between the central recess 35b and the pocket portion 35a. Then, as illustrated in FIG. 10, the holder 35 is placed on the platy first yoke 41, described later, via a spacer 39 and a pair of buffer materials 40.

As illustrated in FIG. 3, a position regulating plate 37 is made of an elastic metal plate with its front surface having a substantially rectangular shape, and the both side edges thereof are cut and raised to form elastic claw portions. The position regulating plate 37 is then press-fitted into the holder 35 (FIG. 11) to regulate the idle running of the movable contactor 49 and a movable yoke 48, described later (FIG. 9).

As illustrated in FIG. 3, the arc elimination piece 38 has a reverse gantry shape in cross section, formed by pressing a thin plate metal. The arc elimination piece 38 is then installed in the recess 35d (FIG. 10) of the holder 35 so as to rapidly cool the arc generated at the time of contact switch and efficiently eliminate the arc.

As illustrated in FIG. 3, the buffer material 40 is a platy body made of an elastic material. The buffer material 40 is then sandwiched between the holder 35 and the platy first yoke 41 covered with the spacer 39 (FIGS. 10 and 11).

As illustrated in FIG. 3, the platy first yoke 41 has a planar shape that can be fitted into the opening of the case 10. In addition, a caulking hole 41a is provided at the center of the platy first yoke 41. The outer peripheral edge of the metal tubular flange 31 is welded and integrated to the outer peripheral edge of the upper surface of the platy first yoke 41. Further, the upper end of the cylindrical fixed iron core 42 is caulked and fixed to the caulking hole 41a of the platy first yoke 41.

As illustrated in FIG. 10, the movable shaft 43 is slidably inserted into a through hole 42a of the cylindrical fixed iron core 42 via the cylindrical insulating portion 35c of the holder 35. An annular guard portion 43a is provided on the upper side of the movable shaft 43. The movable shaft 43 is inserted through a return spring 44, and the movable iron core 45 is fixed to the lower end of the movable shaft 43.

As illustrated in FIG. 10, the movable shaft 43 is inserted sequentially through a receiving portion 47a, a contact spring 47, the movable yoke 48, and the movable contactor 49 from the upper end of the movable shaft 43 and is locked by the annular guard portion 43a. The movable shaft 43 prevents the movable contactor 49 from slipping off by a retaining ring 50 fixed to the upper end of the movable shaft 43.

As illustrated in FIG. 11, the movable yoke 48 is formed by bending and raising both ends of the platy magnetic material in the same direction and in parallel to form bent raised portions 48a, 48a, thereby having a reverse gantry shape in cross section. The movable yoke 48 is in contact with the lower surface of the movable contactor 49.

The movable contacts 49a, 49a are provided by protrusion at both ends of the upper surface of the movable contactor 49. The movable contacts 49a, 49a respectively face the fixed contacts 33a, 33a of the fixed contact terminal 33 disposed in the holder 35 so as to be able to come into contact with and separate from the fixed contacts 33a, 33a.

As illustrated in FIG. 10, the opening edge of the bottomed cylindrical body 46 accommodating the movable iron core 45 is air-tightly joined to the vicinity of the lower surface edge of the caulking hole 41a provided in the platy first yoke 41. After the inside air is sucked from the gas venting pipe 34, the gas venting pipe 34 is filled with gas and sealed, to form a sealed space.

As illustrated in FIG. 3, a fixed yoke 51 is a planar rectangular platy magnetic material and is disposed between the fixed contact terminals 33. The longitudinal (Y1-Y2 direction) linear dimension of the fixed yoke 51 is larger than the longitudinal (Y1-Y2 direction) linear dimension of the movable yoke 48. For this reason, the entire movable yoke 48 overlaps the fixed yoke 51, so that leakage of magnetic flux is small and favorable magnetic efficiency is obtained. As illustrated in FIG. 11, the fixed yoke 51 is bridged over the opening edges of the holder 35 which face each other. The movable yoke 48 has both ends that face both ends of the fixed yoke 51 so as to be able to come into contact with and separate from both ends of the fixed yoke 51. The movable yoke 48 is supported integrally with the movable contactor 49 so as to be able to reciprocate. Therefore, when the fixed contact 33a and the movable contact 49a are joined, the fixed yoke 51 and the movable yoke 48 attract each other based on the current flowing through the movable contactor 49.

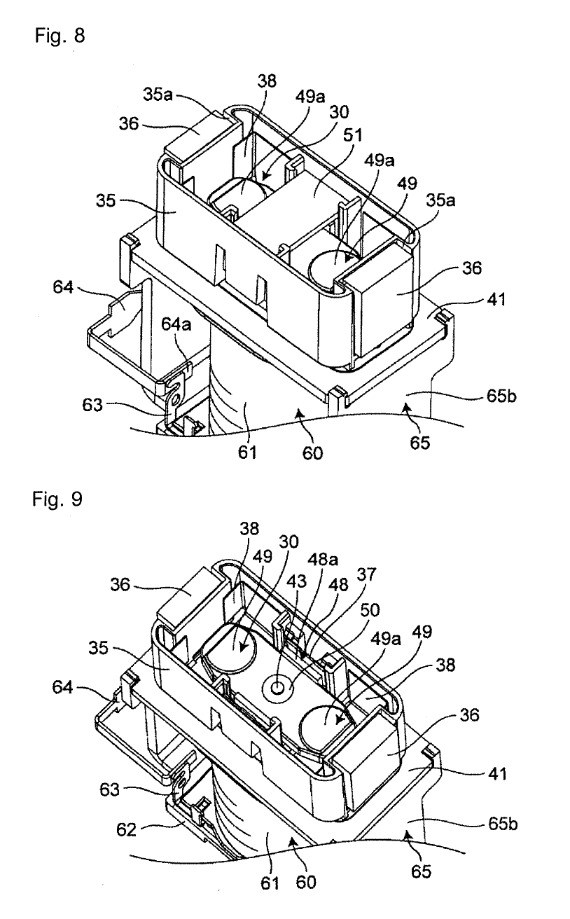

As illustrated in FIGS. 7 and 8, a lid body 52 is an insulating platy body having a planar shape that can be fitted into the opening of the holder 35. The lid body 52 is provided with a pair of terminal holes 52a, 52a.

An inner cover 53 is an elastic body having a three-dimensional shape capable of covering the metal tubular flange 31 to which the ceramic plate 32 is brazed. For the inner cover 53, for example, a rubber material which easily absorbs collision sound may be used. The inner cover 53 is provided with a through hole 53b between a pair of terminal holes 53a, 53a provided on a ceiling surface of the inner cover 53.

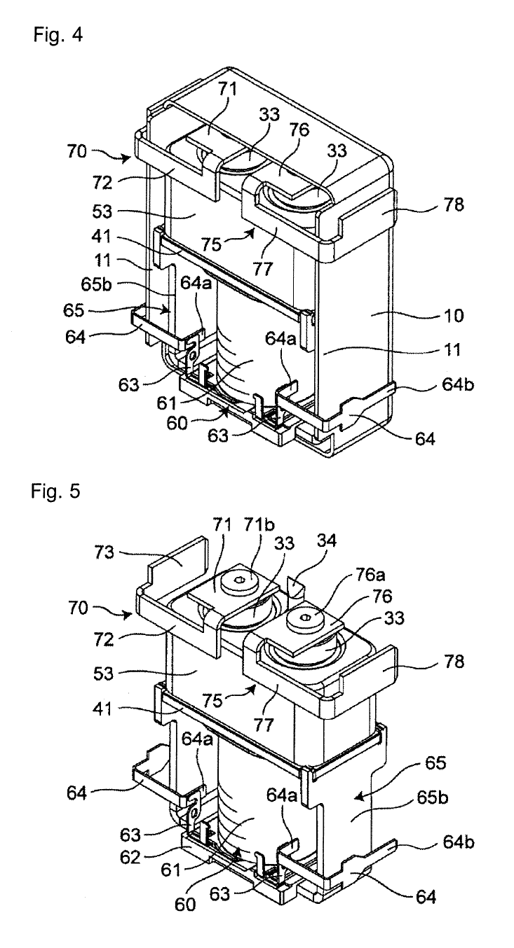

As illustrated in FIG. 3, the electromagnet unit 60 is formed by winding a coil 61 around a body portion of a spool 62. Relay terminals 63, 63 are fixed to the guard portions provided at both ends of the spool 62. Lead wires of the coil 61 are respectively tied and soldered to the relay terminals 63, 63. Further, a connection portion 64a of the coil terminal 64 is connected to each of the relay terminals 63, 63 (FIGS. 4 and 5). A terminal portion 64b of the coil terminal 64 protrudes outward from each of the bulging portions 23, 24 of the outer cover 20.

Then, as illustrated in FIG. 10, the bottomed cylindrical body 46 is inserted through the through hole provided in the spool 62. Subsequently, the lower end of the bottomed cylindrical body 46 is fitted into a fitting hole 65a of a second yoke 65. The upper ends of arm portions 65b, 65b of the second yoke 65 are respectively engaged with both ends of the platy first yoke 41 and fixed thereto (FIG. 7). Examples of a fixing method include caulking, press fitting, and welding. Thereby, the electromagnet unit 60 and the contact mechanism unit 30 are integrated.

As illustrated in FIG. 5, the leading terminals 70, 75 are formed by bending a platy conductive material. The leading terminals 70, 75 respectively include the fixed portions 71, 76 fixed to the fixed contact terminal 33 via hexagonal nuts 71a, 76a, extension portions 72, 77 continuing to the fixed portions 71, 76, and terminal portions 73, 78 provided at the distal ends of the extension portions 72, 77.

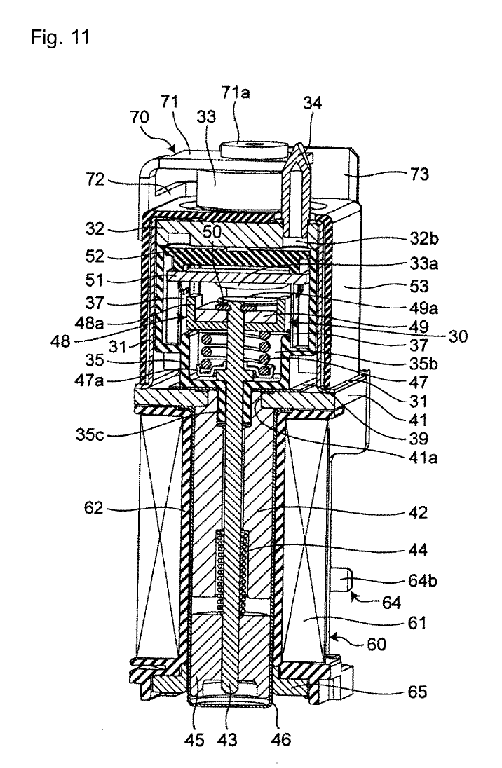

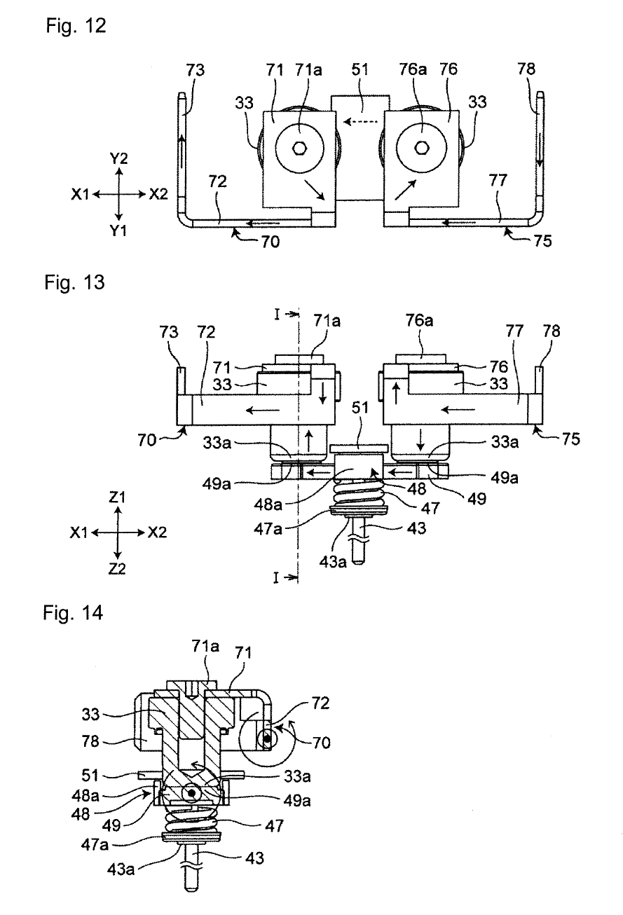

When the fixed portions 71, 76 are respectively fixed to the fixed contact terminals 33, 33, as illustrated in FIGS. 12 and 13, the extension portions 72, 77 are disposed in an X1-X2 direction so as to follow the movable contactor 49, to allow application of a current to the fixed contact terminals 33, 33 and the movable contactor 49 via the pair of leading terminals 70, 75. As illustrated in FIG. 13, the axis of each of the extension portions 72, 77 along the X1-X2 direction is disposed closer to the fixed contact terminal than the joint surface of the fixed contact 33a and the movable contact 49a is, for example, disposed high on the fixed contact terminal 33 side (Z1 direction). The direction of the current flowing through each of the extension portions 72, 77 is equal to the direction of the current flowing through the movable contactor 49.

Next, the operation of the electromagnetic relay with the above-mentioned configuration will be described.

First, as illustrated in FIG. 10, when no voltage is applied to the coil 61, the movable iron core 45 is urged downward (Z2 direction) by the spring force of the return spring 44. Therefore, the movable shaft 43 integral with the movable iron core 45 is pressed downward (toward the Z2 direction), and the movable contactor 49 is pulled downward. At this time, the annular guard portion 43a of the movable shaft 43 is engaged with the bottom surface of the central recess 35b of the holder 35. At this time, the movable contact 49a is separated from the fixed contact 33a, but the movable iron core 45 is not in contact with the bottom surface of the bottomed cylindrical body 46.

Subsequently, when a voltage is applied to the coil 61 for excitation, the movable iron core 45 is attracted to the cylindrical fixed iron core 42. Therefore, the movable shaft 43 slides upward (Z1 direction) against the spring force of the return spring 44. The movable contact 49a then comes into contact with the fixed contact 33a. Further, the movable shaft 43 is pushed up against the spring force of the return spring 44 and the contact spring 47. Therefore, the movable contact 49a and the fixed contact 33a come into pressure contact with each other at predetermined contact pressure. At this time, the movable yoke 48 approaches the fixed yoke 51. However, the fixed yoke 51 and the bent raised portion 48a of the movable yoke 48 do not come into direct contact with each other but constitute a magnetic circuit while maintaining a predetermined air gap. This is to ensure the contact reliability.

Note that the inner cover 53 absorbs and relaxes collision sound which is generated when the movable contact 49a comes into contact with the fixed contact 33a. It is thus possible to obtain a silent electromagnetic relay.

An electromagnetic repulsive force is generated between the fixed contact 33a and the movable contact 49a when the movable contact 49a comes into contact with the fixed contact 33a and a large current flows.

However, as illustrated in FIGS. 13 and 14, the axes of the extension portions 72, 77 are located higher than the joint surfaces of the fixed contact 33a and the movable contact 49a in the Z1 direction. Further, the direction of the current flowing through the movable contactor 49 is equal to the direction of the current flowing through each of the extension portions 72, 77. Therefore, the magnetic force which is generated by the large current flowing through each of the extension portions 72, 77 acts to attract the movable contactor 49 to the fixed contact terminal 33. As a result, the above-mentioned electromagnetic repulsive force which is generated when a large current flows is reduced, the contact reliability improves, and the occurrence of the arc can be prevented.

Further, in the embodiment, the movable yoke 48 and the fixed yoke 51 constitute a magnetic circuit while maintaining a predetermined air gap when the contact is closed. Therefore, magnetic force lines flow through the movable yoke 48 and the fixed yoke 51, and a magnetic circuit is formed. As a result, even when a large current flows through the movable contactor 49 and an electromagnetic repulsive force is generated between the fixed contact 33a and the movable contact 49a, the magnetic circuit formed by the fixed yoke 51 and the movable yoke 48 attracts the movable yoke 48 to the fixed yoke 51 to suppress the electromagnetic repulsive force.

Therefore, according to the embodiment, it is advantageous that the contact reliability improves and the occurrence of arc and contact welding can be prevented by preventing contact pressure reduction and contact opening separation.

When the application of the voltage to the coil 61 is stopped and the excitation is released, the movable iron core 45 is separated from the cylindrical fixed iron core 42 by the spring force of the contact spring 47 and the return spring 44. Therefore, after the movable shaft 43 slides downward (Z2 direction) and the movable contact 49a is separated from the fixed contact 33a, the annular guard portion 43a of the movable shaft 43 engages with the central recess 35b of the holder 35 and returns to the original state (FIGS. 10 and 11).

According to the embodiment, the impact force of the movable shaft 43 is absorbed and relaxed by the buffer material 40 via the holder 35. In particular, even when the movable shaft 43 returns to the original state, the movable iron core 45 does not come into contact with the bottom surface of the bottomed cylindrical body 46. Therefore, the collision sound of the movable shaft 43 is absorbed and relaxed by the holder 35, the buffer material 40, the cylindrical fixed iron core 42, the inner cover 53, the electromagnet unit 60, and the like. As a result, there is an advantage that a sealed electromagnetic relay with small switch sound can be obtained.

Further, with the position regulating plate 37 of the embodiment, as illustrated in FIG. 11, by the movable shaft 43 moving up and down, the movable contactor 49 moves up and down. At that time, even if the movable contactor 49 and the movable yoke 48 are displaced, the movable yoke 48 comes into contact with the position regulating plate 37 press-fitted into the holder 35 to be positionally regulated. Therefore, the movable contactor 49 and the movable yoke 48 do not come into direct contact with the inner peripheral surface of the holder 35 made of resin. As a result, no resin powder is generated and no contact failure occurs. In particular, the position regulating plate 37 is formed of a metal material, and hence abrasion powder is less likely to be generated.

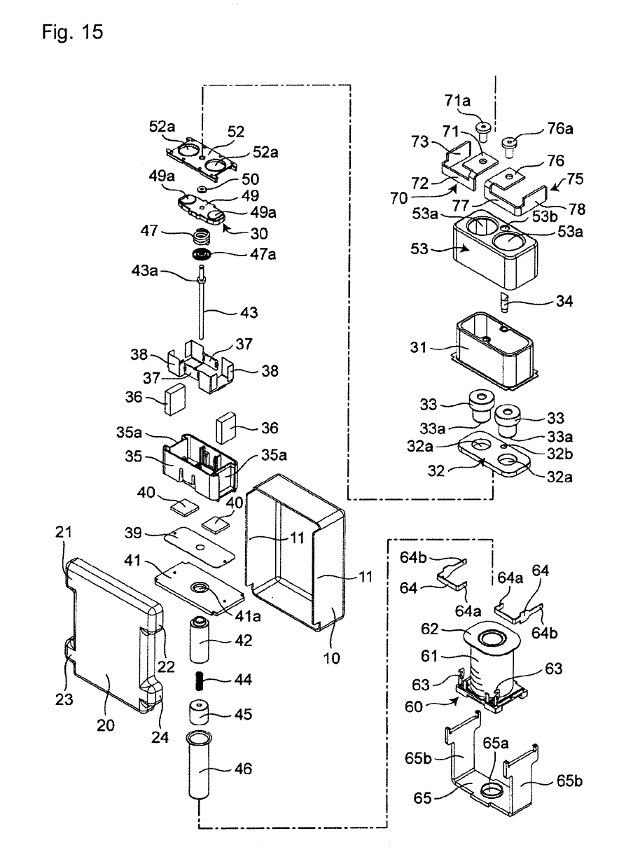

As illustrated in FIGS. 15 to 20, a second embodiment is mostly the same as the first embodiment described above except that the fixed yoke and the movable yoke are not provided.

According to the embodiment, it is possible to obtain an electromagnetic relay with low parts count, low assembly man-hour, and high productivity.

Since the other portions of the embodiment are mostly the same as those of the first embodiment described above, the same reference numerals are provided to the same portions and the description thereof is omitted.

As illustrated in FIGS. 21 to 24, a third embodiment is mostly the same as the first embodiment described above except that the terminal portions 73, 78 of the leading terminals 70, 75 are led out in the opposite directions.

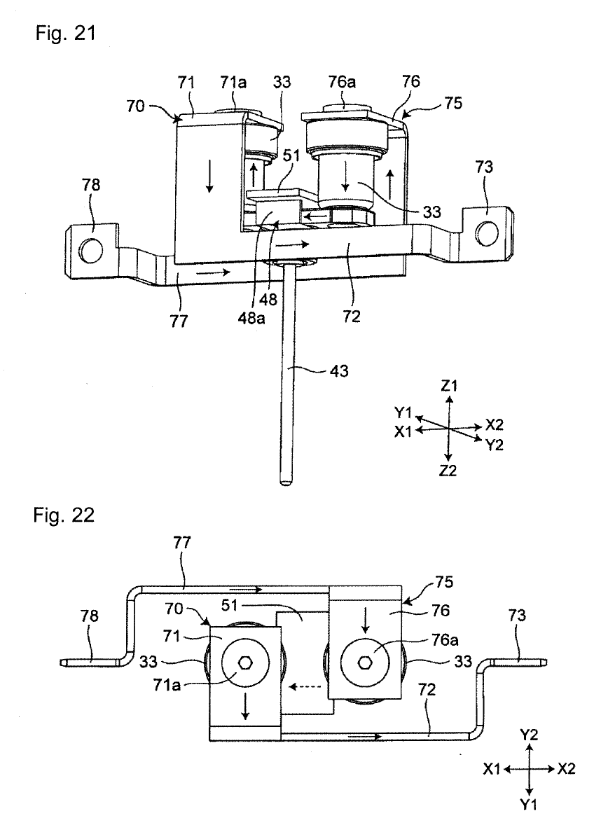

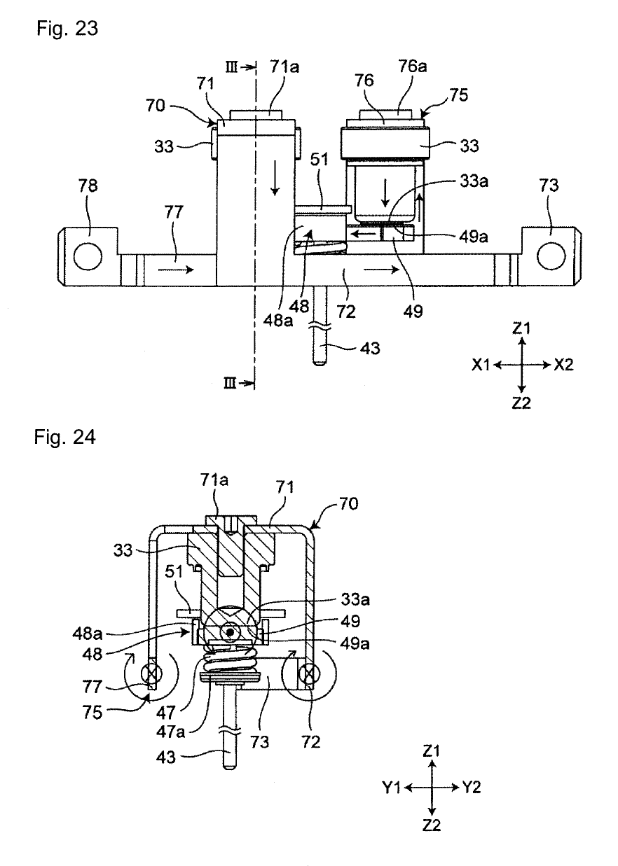

That is, as illustrated in FIG. 22, the leading terminal 70 and the leading terminal 75 have a shape that is bent so as to be point symmetrical. Then, the extension portion 72 extends in the X2 direction, and the extension portion 77 extends in the X1 direction. Further, as illustrated in FIG. 23, the axis of each of the extension portions 72, 77 along the X1-X2 direction is disposed closer to the movable contactor than the joint surface of the fixed contact 33a and the movable contact 49a is, for example, disposed low in the Z2 direction. The direction of the current flowing through each of the extension portions 72, 77 and the direction of the current flowing through the movable contactor 49 are the opposite directions.

Since the other portions of the embodiment are mostly the same as those of the first embodiment described above, the same reference numerals are provided to the same portions and the description thereof is omitted.

According to the embodiment, as illustrated in FIGS. 23 and 24, when the movable contact 49a comes into contact with the fixed contact 33a and a large current flows, an electromagnetic repulsive force is generated between the fixed contact 33a and the movable contact 49a.

However, the axes of the extension portions 72, 77 are located lower than the joint surface of the fixed contact 33a and the movable contact 49a in the Z2 direction. Further, the direction of the current flowing through the movable contactor 49 and the direction of the current flowing through each of the extension portions 72, 77 are the opposite directions. Therefore, the magnetic force generated by the large current flowing through each of the extension portions 72, 77 acts in a direction repelling against the magnetic force generated in the movable contactor 49. As a result, the magnetic force generated in each of the extension portions 72, 77 pushes up the movable contactor 49 in the Z1 direction, so that the electromagnetic repulsive force is reduced. As a result, the contact reliability improves, and the occurrence of arc can be prevented.

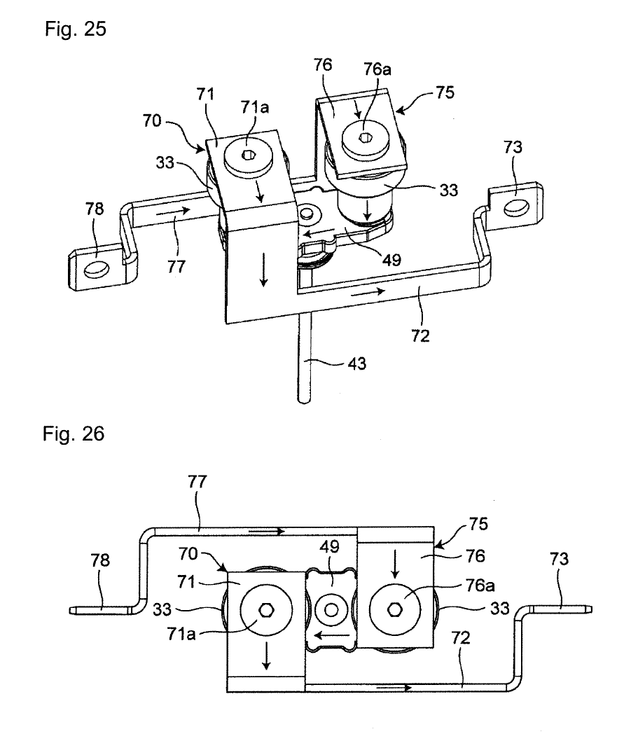

As illustrated in FIGS. 25 to 28, a fourth embodiment is mostly the same as the third embodiment described above except that the fixed yoke and the movable yoke are not provided.

According to the embodiment, it is possible to obtain an electromagnetic relay with low parts count, low assembly man-hour, and high productivity.

Since the other portions of the embodiment are mostly the same as those of the third embodiment described above, the same reference numerals are provided to the same portions and the description thereof is omitted.

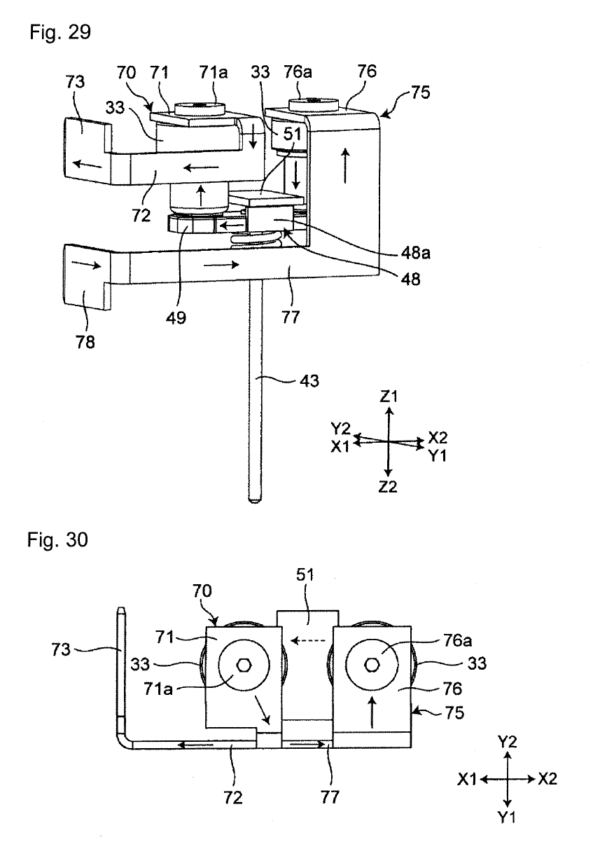

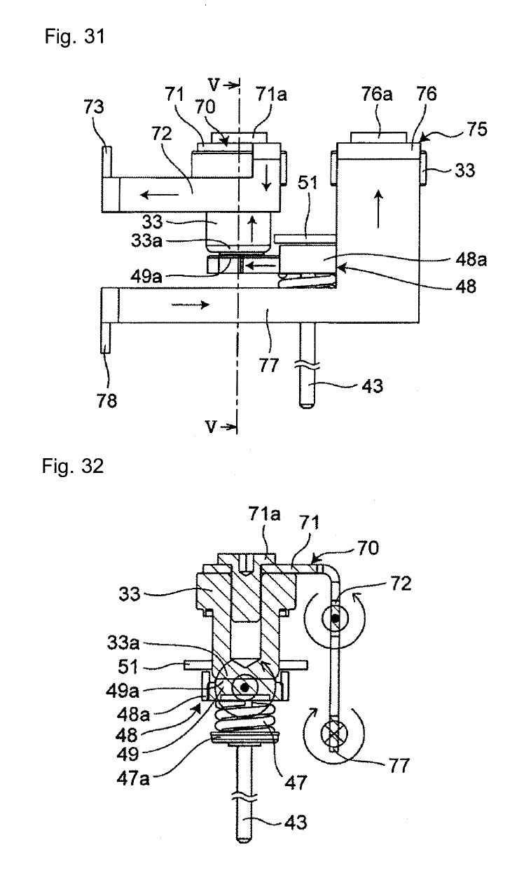

As illustrated in FIGS. 29 to 32, a fifth embodiment is the same as the first embodiment described above except that the extension portions 72, 77 of the leading terminals 70, 75 are led out in the same direction (X1 direction), and the extension portions 72, 77 are disposed in the vertical direction (Z1-Z2 direction). That is, the extension portion 72 of the leading terminal 70 extends along the X1 direction and the terminal portion 73 is led out in the Y2 direction. The extension portion 77 of the leading terminal 75 also extends along the X direction, and the terminal portion 78 is led out in the Y2 direction. Further, as illustrated in FIGS. 31 and 32, the axis of the extension portion 72 and the axis of the extension portion 77 are disposed vertically (Z1-Z2 direction) with the joint surfaces of the fixed contact 33a and the movable contact 49a interposed therebetween.

Since the other portions of the embodiment are mostly the same as those of the first embodiment described above, the same reference numerals are provided to the same portions and the description thereof is omitted.

According to the embodiment, as illustrated in FIGS. 31 and 32, when the movable contact 49a comes into contact with the fixed contact 33a and a large current flows, an electromagnetic repulsive force is generated between the fixed contact 33a and the movable contact 49a.

However, the axis of the extension portion 72 is located higher than the joint surface of the fixed contact 33a and the movable contact 49a in the Z1 direction. On the other hand, the axis of the extension portion 77 is located lower than the joint surface of the fixed contact 33a and the movable contact 49a in the Z2 direction.

The direction of the current flowing through the movable contactor 49 is equal to the direction of the current flowing through the extension portion 72. On the other hand, the direction of the current flowing through the movable contactor 49 and the direction of the current flowing through the extension portion 77 are the opposite directions.

Therefore, when a large current flows in each of the extension portions 72, 77 and a magnetic force is generated, the magnetic force generated in the extension portion 72 acts to pull up the movable contactor 49 in the Z1 direction, and the magnetic force generated in the extension portion 77 acts to push up the movable contactor 49 in the Z1 direction. As a result, the electromagnetic repulsive force described above is reduced by the magnetic force generated in each of the extension portions 72, 77, so that the contact reliability improves and the occurrence of the arc can be prevented.

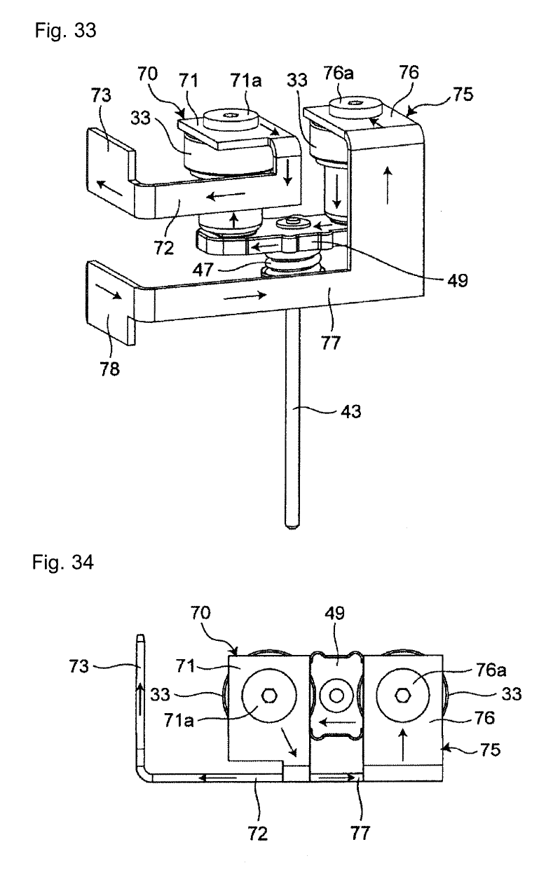

As illustrated in FIGS. 33 to 36, a sixth embodiment is mostly the same as the fifth embodiment described above except that the fixed yoke and the movable yoke are not provided.

According to the embodiment, it is possible to obtain an electromagnetic relay with low parts count, low assembly man-hour, and high productivity.

Since the other portions of the embodiment are mostly the same as those of the fifth embodiment described above, the same reference numerals are provided to the same portions and the description thereof is omitted.

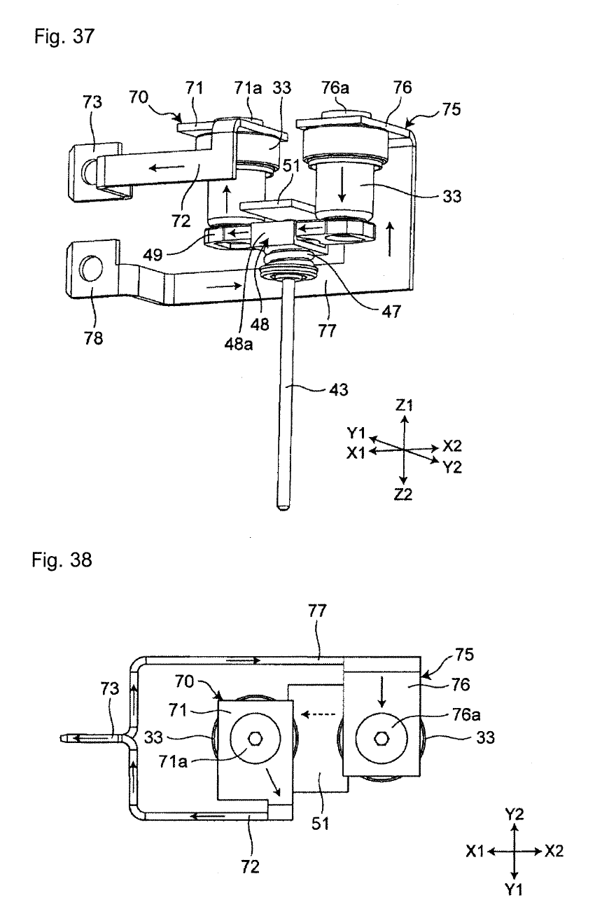

As illustrated in FIGS. 37 to 40, a seventh embodiment is the same as the first embodiment described above except that the leading terminals 70, 75 are led out in the same direction and the extension portions 72, 77 are disposed vertically.

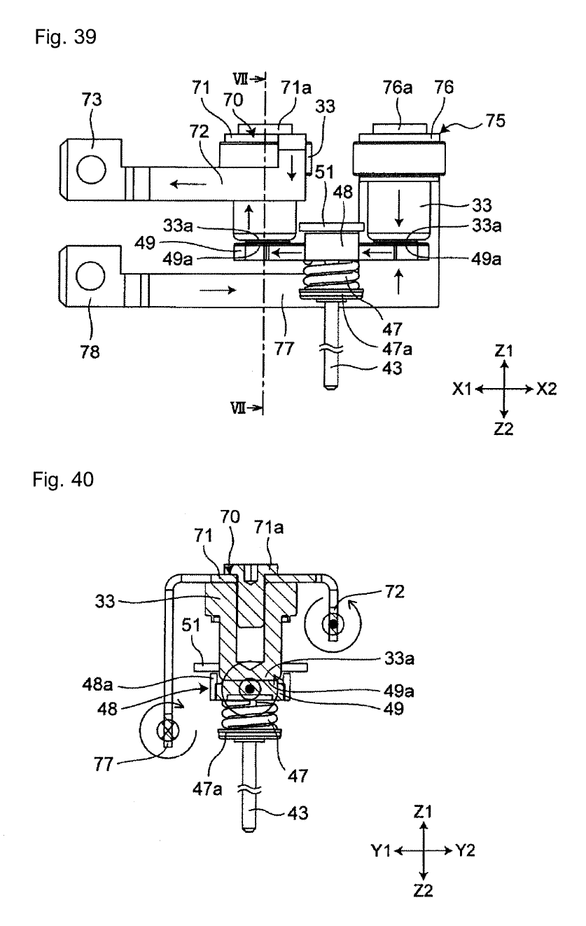

That is, the extension portion 72 of the leading terminal 70 extends along the X1 direction, and the terminal portion 73 is also led out along the X1 direction. The extension portion 77 of the leading terminal 75 extends along the X1 direction, and the terminal portion 78 is also led out along the X1 direction. Further, as illustrated in FIGS. 39 and 40, the axis of the extension portion 72 and the axis of the extension portion 77 are disposed vertically (Z1-Z2 direction) with the joint surface of the fixed contact 33a and the movable contact 49a interposed therebetween.

Since the other portions of the embodiment are mostly the same as those of the first embodiment described above, the same reference numerals are provided to the same portions and the description thereof is omitted.

According to the embodiment, as illustrated in FIGS. 39 and 40, when the movable contact 49a comes into contact with the fixed contact 33a and a large current flows, an electromagnetic repulsive force is generated between the fixed contact 33a and the movable contact 49a.

However, the axis of the extension portion 72 is located higher than the joint surface of the fixed contact 33a and the movable contact 49a in the Z1 direction. On the other hand, the axis of the extension portion 77 is located lower than the joint surface of the fixed contact 33a and the movable contact 49a in the Z2 direction.

The direction of the current flowing through the movable contactor 49 is equal to the direction of the current flowing through the extension portion 72.

On the other hand, the direction of the current flowing through the movable contactor 49 and the direction of the current flowing through the extension portion 77 are the opposite directions.

Therefore, when a large current flows in each of the extension portions 72, 77 and a magnetic force is generated, the magnetic force generated in the extension portion 72 acts to pull up the movable contactor 49 in the Z1 direction, and the magnetic force generated in the extension portion 77 acts to push up the movable contactor 49 in the Z1 direction. As a result, the magnetic force generated in each of the extension portions 72, 77 reduces the electromagnetic repulsive force, so that the contact reliability improves and the occurrence of the arc can be prevented.

As illustrated in FIGS. 41 to 44, an eighth embodiment is mostly the same as the seventh embodiment described above except that the fixed yoke and the movable yoke are not provided.

According to the embodiment, it is possible to obtain an electromagnetic relay with low parts count, low assembly man-hour, and high productivity.

Since the other portions of the embodiment are mostly the same as those of the seventh embodiment described above, the same reference numerals are provided to the same portions and the description thereof is omitted.

A variety of embodiments of the present invention have been described in detail with reference to the drawings, and lastly, a variety of aspects of the present invention will be described.

For solving the above problem, an electromagnetic relay according to a first aspect of the present invention is configured as follows. A contact switching device includes: a pair of fixed contact terminals that include fixed contacts at one-side ends and are arranged side by side; a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts; and a pair of leading terminals configured to respectively fix fixed portions, provided at one-side ends, to other-side ends of the fixed contact terminals. An extension portion continuing to each of the fixed portions of at least one of the leading terminals is disposed so as to follow the movable contactor, and a current is applied to each of the fixed contact terminals and the movable contactor via the pair of leading terminals.

According to the first aspect of the present invention, when a large current flows between the fixed contact and the movable contact, the large current flowing through the extension portion generates a magnetic field, and the magnetic force of the magnetic field can reduce an electromagnetic repulsive force generated between the fixed contact and the movable contact. In particular, it is not necessary to increase the number of turns of a coil in an electromagnet unit in order to increase an attractive force between the contacts. It is thus possible to improve the contact reliability while avoiding an increase in size of the device.

A second aspect of the present invention is configured as follows. In the first aspect, namely, a contact switching device includes: a pair of fixed contact terminals that include fixed contacts at one-side ends and are arranged side by side; a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts; and a pair of leading terminals configured to respectively fix fixed portions, provided at one-side ends, to other-side ends of the fixed contact terminals. An extension portion continuing to each of the fixed portions of at least one of the leading terminals is disposed so as to follow the movable contactor, an axis of the extension portion is disposed closer to the fixed contact terminals than joint surfaces of the fixed contacts and the movable contacts are, and a direction of a current flowing through the movable contactor is equal to a direction of a current flowing through the extension portion.

According to the second aspect, the direction of the magnetic field generated in the movable contactor is equal to the direction of the magnetic field generated in the extension portion. Therefore, the magnetic force generated in the extension portion acts to attract the movable contactor. As a result, it is possible to reduce the electromagnetic repulsive force generated between the fixed contact and the movable contact by the magnetic force of the extension portion and improve the contact reliability without increasing the size of the device.

A third aspect of the present invention may be configured as follows. In the first aspect, namely, a contact switching device includes: a pair of fixed contact terminals that include fixed contacts at one-side ends and are arranged side by side; a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts; and a pair of leading terminals configured to respectively fix fixed portions, provided at one-side ends, to other-side ends of the fixed contact terminals. An extension portion continuing to each of the fixed portions of at least one of the leading terminals is disposed so as to follow the movable contactor, an axis of the extension portion is disposed closer to the movable contactor than joint surfaces of the fixed contacts and the movable contacts are, and a direction of a current flowing through the movable contactor is opposite to a direction of a current flowing through the extension portion of each of the leading terminals.

According to the third aspect, the direction of the magnetic field generated in the movable contactor and the direction of the magnetic field generated in the extension portion are the opposite directions. Therefore, the magnetic force generated in the extension portion acts so as to repel the movable contactor, and the movable contact provided in the movable contactor is pushed toward the fixed contact. As a result, it is possible to reduce the electromagnetic repulsive force generated between the fixed contact and the movable contact by the magnetic force of the extension portion and improve the contact reliability without increasing the size of the device.

A fourth aspect of the present invention may be configured as follows. In the first aspect, namely, a contact switching device includes: a pair of fixed contact terminals that include fixed contacts at one-side ends and are arranged side by side; a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts; and a pair of leading terminals configured to respectively fix fixed portions, provided at one-side ends, to other-side ends of the fixed contact terminals. An extension portion continuing to the fixed portion of one of the leading terminals is disposed so as to follow the movable contactor, an axis of the extension portion of at least one of the leading terminals is disposed closer to the fixed contact terminals than joint surfaces of the fixed contacts and the movable contacts are, and while a direction of a current flowing through the movable contactor is equal to a direction of a current flowing through the extension portion of each of the leading terminals, the extension portion continuing to the fixed portion of the remaining other of the leading terminals is disposed so as to follow the movable contactor, an axis of the extension portion is disposed closer to the movable contactor than joint surfaces of the fixed contacts and the movable contacts are, and a direction of a current flowing through the movable contactor is opposite to a direction of a current flowing through the extension portion of each of the leading terminals.

According to the fourth aspect, the magnetic force generated in one extension portion attracts the movable contact to the fixed contact. On the other hand, the magnetic force generated in the remaining extension portion presses the movable contact to the fixed contact. It is thus possible to reduce the electromagnetic repulsive force generated between the fixed contact and the movable contact by the magnetic force generated at the pair of extension portions. As a result, it is possible to obtain a contact switching device of a small size with high contact reliability.

A fifth aspect of the present invention may be configured as follows. In any one of the first to fourth aspects, namely, a contact switching device includes: a fixed yoke disposed between the fixed contact terminals; and a movable yoke having both ends that face both ends of the fixed yoke so as to be able to come into contact with and separate from the both ends, and supported integrally with the movable contactor so as to be able to reciprocate. When the fixed contact and the movable contact are joined, the fixed yoke and the movable yoke attract each other based on the current flowing through the movable contactor.

According to the fifth aspect, when a large current flows between the fixed contact and the movable contact, the movable yoke is attracted to the fixed yoke by the magnetic force generated by the current flowing through the movable contactor. It is thus possible to reduce the electromagnetic repulsive force which is generated when the movable contact is attracted to the fixed contact. As a result, it is possible to improve the contact reliability without increasing the size of the device.

An electromagnetic relay according to a sixth aspect of the present invention is configured as follows. An electromagnetic relay includes: the contact switching device according to any one of the first to fifth aspects; and an electromagnet unit configured to drive the contact switching device. The movable contactor is supported so as to reciprocate toward the fixed contact terminal based on excitation and demagnetization of the electromagnet unit.

According to the sixth aspect of the present invention, when a large current flows between the fixed contact and the movable contact, the large current flowing through the extension portion generates a magnetic field, and the magnetic force of the magnetic field can reduce an electromagnetic repulsive force generated between the fixed contact and the movable contact. In particular, it is not necessary to increase the number of turns of a coil in an electromagnet unit in order to increase an attractive force between the contacts. Therefore, there is an effect that an electromagnetic relay of a small size with high contact reliability is obtained.

By appropriately combining freely selected embodiments or modifications of the above variety of embodiments and modifications, it is possible to achieve the respective effects of those combined. While it is possible to combine embodiments, combine examples, or combine an embodiment and an example, it is also possible to combine features in different embodiments or examples.

While the present invention has been fully described in connection with the preferred embodiments with reference to the accompanying drawings, a variety of modifications or amendments will be apparent to those skilled in the art. Such modifications or amendments are to be understood as being included in the scope of the invention according to the appended claims so long as not deviating therefrom.

### INDUSTRIAL APPLICABILITY

It is a matter of course that the contact switch according to the above aspects of the present invention is not limited to the case of being applied to the electromagnetic relay described above but may be applied to other contact switches.

### DESCRIPTION OF SYMBOLS

10 case
11 fitting rib
20 outer cover
21 bulging portion
22 bulging portion
23 bulging portion
24 bulging portion
30 contact mechanism unit
31 metal tubular flange
32 ceramic plate
32a terminal hole
32b gas venting hole
33 fixed contact terminal
33a fixed contact
34 gas venting pipe
35 holder
35a pocket portion
35b central recess
35c cylindrical insulating portion
36 permanent magnet
37 position regulating plate
38 arc elimination piece
39 spacer
40 buffer material
41 platy first yoke
41a caulking hole
42 cylindrical fixed iron core
43 movable shaft
43a annular guard portion
44 return spring
45 movable iron core
46 bottomed cylindrical body
47 contact spring
47a receiving portion
48 movable yoke
48a bent raised portion
49 movable contactor
49a movable contact
50 retaining ring
51 fixed yoke
52 lid body
52a terminal hole
53 inner cover
60 electromagnet unit
61 coil
62 spool
63 relay terminal
64 coil terminal
65 second yoke
65a fitting hole
65b arm portion
70 leading terminal
71 fixed portion
72 extension portion
73 terminal portion
75 leading terminal
76 fixed portion
77 extension portion
78 terminal portion

1. A contact switching device comprising:
a pair of fixed contact terminals that include fixed contacts at one-side ends and are arranged side by side;
a movable contactor that includes a pair of movable contacts at both ends, and are disposed so as to bridge between the pair of fixed contact terminals, and supported so as to be able to reciprocate towards the fixed contact terminals, each of the movable contacts facing each of the fixed contacts so as to be able to come into contact with and separate from each of the fixed contacts; and
a pair of leading terminals configured to respectively fix fixed portions, provided at one-side ends, to other-side ends of the fixed contact terminals,
wherein an extension portion continuing to each of the fixed portions of at least one of the leading terminals is disposed so as to follow the movable contactor, and
a current is applied to each of the fixed contact terminals and the movable contactor via the pair of leading terminals.

2. The contact switching device according to claim 1, wherein
an axis of the extension portion is disposed closer to the fixed contact terminals than joint surfaces of the fixed contacts and the movable contacts are, and
a direction of a current flowing through the movable contactor is equal to a direction of a current flowing through the extension portion.

3. The contact switching device according to claim 1, wherein
an axis of the extension portion is disposed closer to the movable contactor than joint surfaces of the fixed contacts and the movable contacts are, and
a direction of a current flowing through the movable contactor is opposite to a direction of a current flowing through the extension portion of each of the leading terminals.

4. The contact switching device according to claim 1, wherein
an axis of the extension portion of at least one of the leading terminals is disposed closer to the fixed contact terminals than joint surfaces of the fixed contacts and the movable contacts are, and
while a direction of a current flowing through the movable contactor is equal to a direction of a current flowing through the extension portion of each of the leading terminals,
the extension portion continuing to the fixed portion of the remaining other of the leading terminals is disposed so as to follow the movable contactor, an axis of the extension portion is disposed closer to the movable contactor than joint surfaces of the fixed contacts and the movable contacts are, and a direction of a current flowing through the movable contactor is opposite to a direction of a current flowing through the extension portion of each of the leading terminals.

5. The contact switching device according to claim 1, further comprising:
a fixed yoke disposed between the fixed contact terminals; and
a movable yoke having both ends that face both ends of the fixed yoke so as to be able to come into contact with and separate from the both ends of the fixed yoke, and supported integrally with the movable contactor so as to be able to reciprocate,
wherein, when the fixed contact and the movable contact are joined, the fixed yoke and the movable yoke attract each other based on the current flowing through the movable contactor.

6. An electromagnetic relay, comprising:
the contact switching device according to claim 1; and
an electromagnet unit configured to drive the contact switching device,
wherein the movable contactor is supported so as to reciprocate toward the fixed contact terminals based on excitation and demagnetization of the electromagnet unit.

7. The contact switching device according to claim 2, further comprising:
a fixed yoke disposed between the fixed contact terminals; and
a movable yoke having both ends that face both ends of the fixed yoke so as to be able to come into contact with and separate from the both ends of the fixed yoke, and supported integrally with the movable contactor so as to be able to reciprocate,
wherein, when the fixed contact and the movable contact are joined, the fixed yoke and the movable yoke attract each other based on the current flowing through the movable contactor.

8. The contact switching device according to claim 3, further comprising:
a fixed yoke disposed between the fixed contact terminals; and
a movable yoke having both ends that face both ends of the fixed yoke so as to be able to come into contact with and separate from the both ends of the fixed yoke, and supported integrally with the movable contactor so as to be able to reciprocate,
wherein, when the fixed contact and the movable contact are joined, the fixed yoke and the movable yoke attract each other based on the current flowing through the movable contactor.

9. The contact switching device according to claim 4, further comprising:
a fixed yoke disposed between the fixed contact terminals; and
a movable yoke having both ends that face both ends of the fixed yoke so as to be able to come into contact with and separate from the both ends of the fixed yoke, and supported integrally with the movable contactor so as to be able to reciprocate,
wherein, when the fixed contact and the movable contact are joined, the fixed yoke and the movable yoke attract each other based on the current flowing through the movable contactor.

10. An electromagnetic relay, comprising:
the contact switching device according to claim 2; and
an electromagnet unit configured to drive the contact switching device,
wherein the movable contactor is supported so as to reciprocate toward the fixed contact terminals based on excitation and demagnetization of the electromagnet unit.

11. An electromagnetic relay, comprising:
the contact switching device according to claim 3; and
an electromagnet unit configured to drive the contact switching device,
wherein the movable contactor is supported so as to reciprocate toward the fixed contact terminals based on excitation and demagnetization of the electromagnet unit.

12. An electromagnetic relay, comprising:
the contact switching device according to claim 4; and
an electromagnet unit configured to drive the contact switching device,
wherein the movable contactor is supported so as to reciprocate toward the fixed contact terminals based on excitation and demagnetization of the electromagnet unit.

13. An electromagnetic relay, comprising:
the contact switching device according to claim 5; and
an electromagnet unit configured to drive the contact switching device,
wherein the movable contactor is supported so as to reciprocate toward the fixed contact terminals based on excitation and demagnetization of the electromagnet unit.

14. An electromagnetic relay, comprising:
the contact switching device according to claim 7; and
an electromagnet unit configured to drive the contact switching device,
wherein the movable contactor is supported so as to reciprocate toward the fixed contact terminals based on excitation and demagnetization of the electromagnet unit.

15. An electromagnetic relay, comprising:
the contact switching device according to claim 8; and
an electromagnet unit configured to drive the contact switching device,
wherein the movable contactor is supported so as to reciprocate toward the fixed contact terminals based on excitation and demagnetization of the electromagnet unit.

16. An electromagnetic relay, comprising:
the contact switching device according to claim 9; and
an electromagnet unit configured to drive the contact switching device,
wherein the movable contactor is supported so as to reciprocate toward the fixed contact terminals based on excitation and demagnetization of the electromagnet unit.
